(19) United States
(12) Patent Application Publication
(10) Pub. No.: US 2017/0262826 A1
(43) Pub. Date: Sep. 14, 2017

(54) A VIRTUAL SALES, PAYMENT AND REPORTING METHOD AND E-CASH REGISTER POS SYSTEM

(71) Applicant: RÍNA BÍLÍSÍM TEKNOLOJÍLERÍ ANONÍM SÍRKETÍ, Ístanbul (TR)

(72) Inventor: Burhanettin BULUT, Istanbul (TR)

(73) Assignee: RÍNA BÍLÍSÍM TEKNOLOJÍLERÍ ANONÍM SÍRKETÍ, Ístanbul (TR)

(21) Appl. No.: 15/504,010

(22) PCT Filed: Aug. 14, 2015
(86) PCT No.: PCT/TR2015/050068

§ 371 Date: Feb. 14, 2017

(30) Foreign Application Priority Data
Aug. 14, 2014 (TR) 2014/09495
Aug. 12, 2015 (TR) 2015/10002

(51) Int. Cl. G06Q 20/20; G06Q 20/12; G07F 7/08; G06Q 20/06

(52) U.S. Cl. CPC G06Q 20/202; G06Q 20/065; G06Q 20/12; G07F 7/0826

(57) ABSTRACT

The present invention is related to virtual sales, payment and reporting method and an e-cash register pos system which operates in compliance with said method which can be used in all kinds of stores that can be reached via the internet, or any kind of devices such as telephones, smart devices, smart kiosks, etc, which enables the purchasing of all kinds of goods and services by means of any kind of electronic medium; which provides the financial recording of said purchases, generation of sales receipts of invoices for said purchases, being able to receive payment of said goods services by the cash register pos, and transferring if necessary the above mentioned information to the related organizations or institutions.

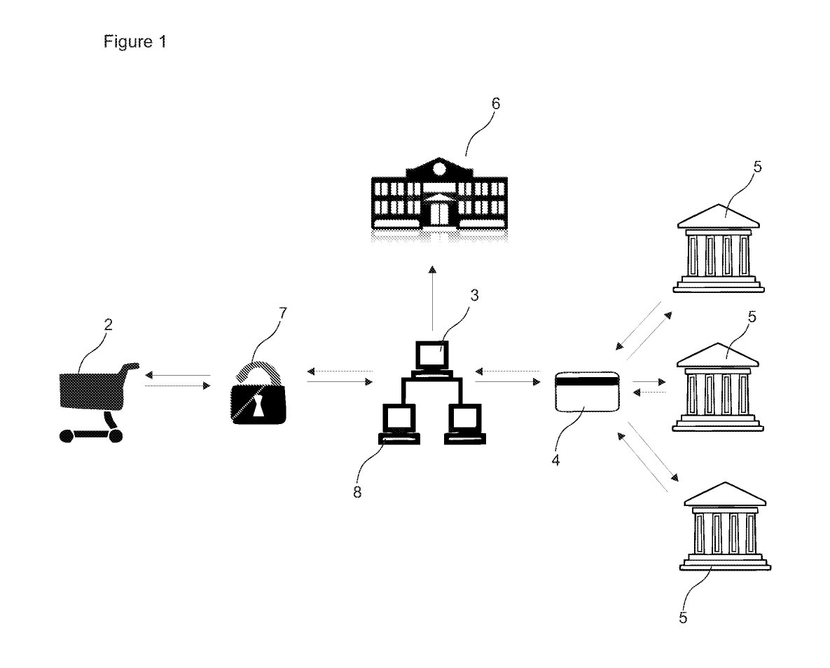

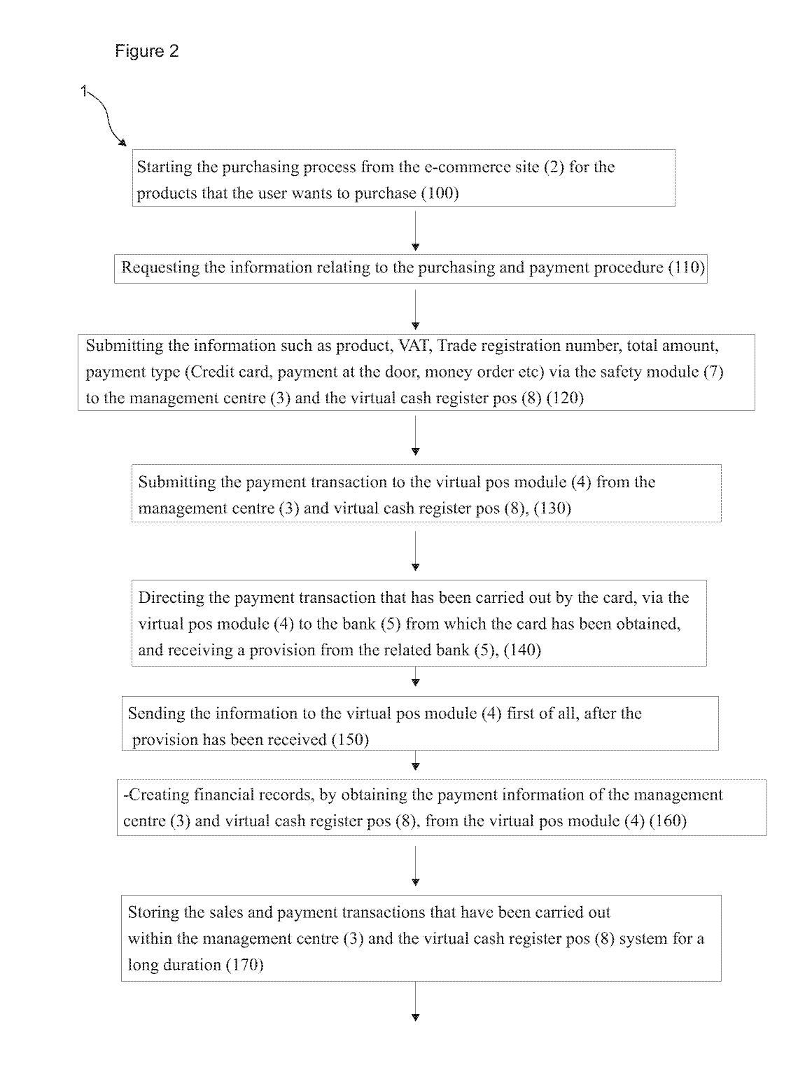

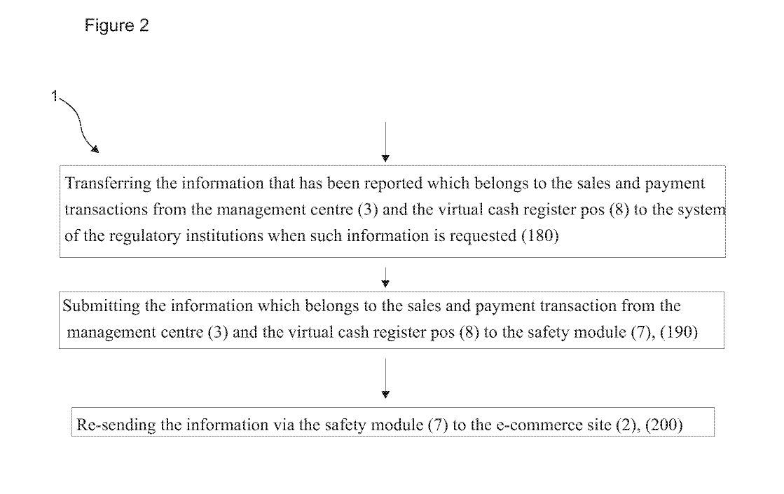

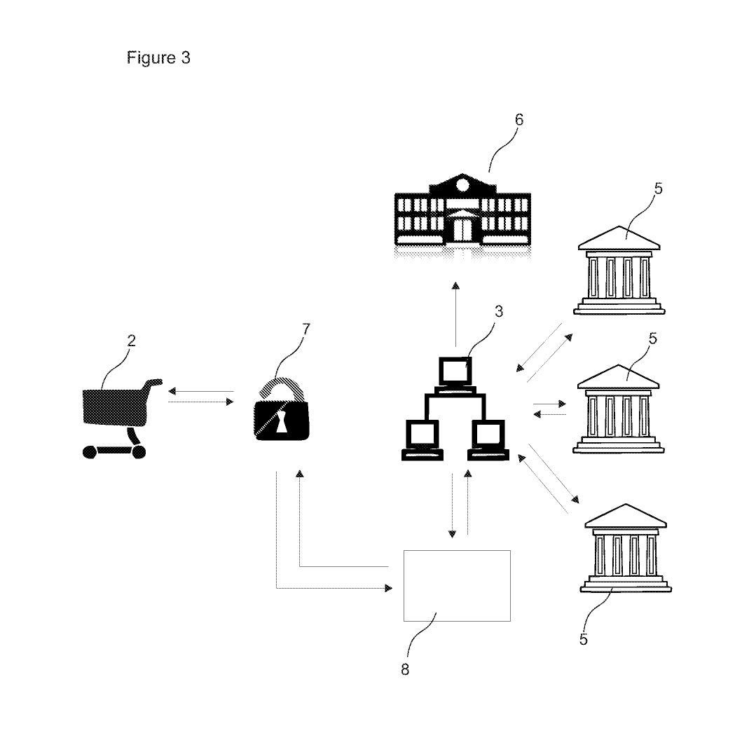

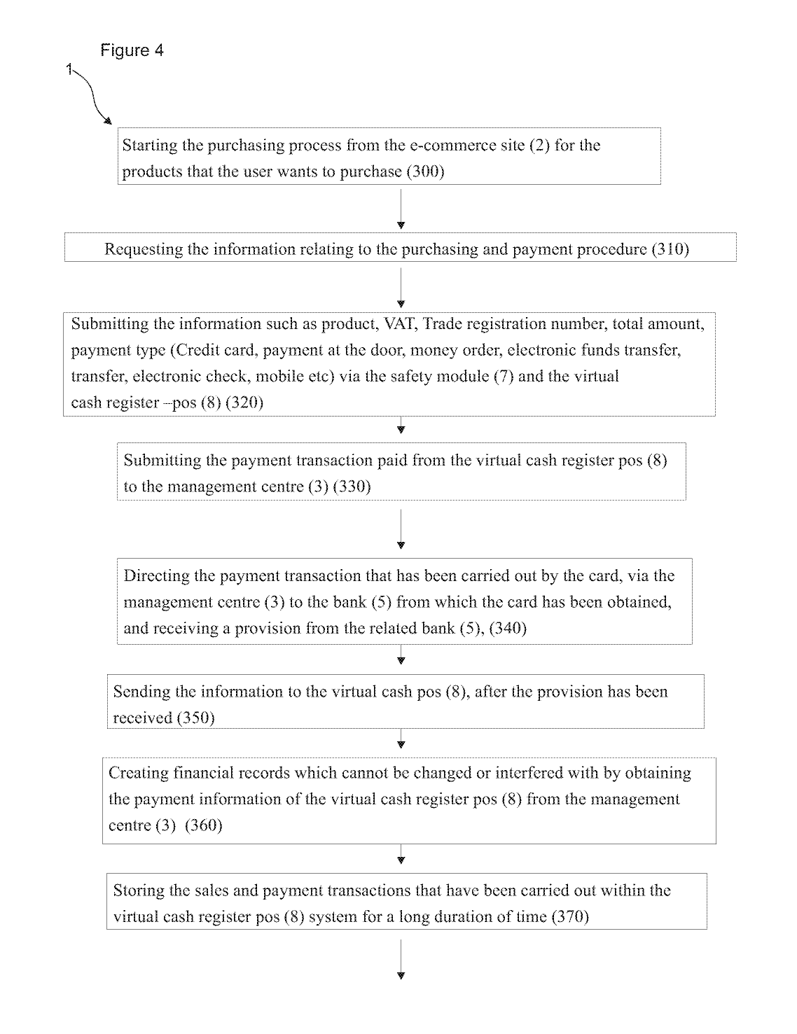

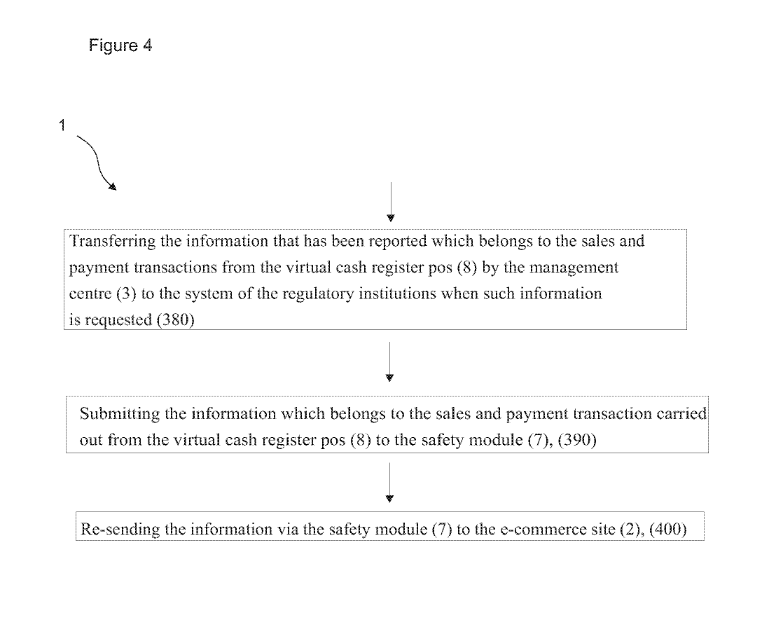

### CROSS REFERENCE TO RELATED APPLICATIONS

This application is the national phase entry of International Application No. PCT/TR2015/050068, filed on Aug. 14, 2015, which is based upon and claims priority to Turkish Patent Application No. 2014/09495 filed on Aug. 14, 2014, and Turkish Patent Application No. 2015/10002 filed on Aug. 12, 2015, the entire contents of which are incorporated herein by reference.

### TECHNICAL FIELD

The present invention is related to virtual sales, payment and reporting method and an e-cash register pos system which operates in compliance with said method which can be used in all kinds of stores that can be reached via the internet, or any kind of devices such as telephones, smart devices, smart kiosks, etc, which enables the purchasing of all kinds of goods and services by means of any kind of electronic medium; which provides the financial recording of said purchases, generation of sales receipts of invoices for said purchases, being able to receive payment of said goods services by the cash register pos, and transferring if necessary the above mentioned information to the related organizations or institutions (regulatory institutions). By means of the system which operates according to this method and said method, enables the storage of the information created during sales and purchasing for the duration of the legal record keeping period, archiving said information electronically and transferring said information when desired, periodically or instantly to the authorized organizations.

### BACKGROUND

In to the prior art, the purchasing carried out via the internet were invoiced according to the initiative of the seller and in many cases said sales were not financially recorded. In said systems any kind of financial records, are not present electronically regarding the content of the sales that has been performed. The declaration of the income obtained from the sales of goods and services which have been paid by credit cards only (payment records are kept via virtual pos) are submitted to the related organizations and institutions depending on the initiative of the tax payer. In such cases, it is impossible for the authorized organizations and institutions to reach the past and correct data. In the system of the prior art, only a virtual pos is provided and it is known that the sales carried out virtually does not create any financial data.

The most important problem within the known state of the art is that, while a financial print out is provided in relation to the sales procedure that has been carried out, a financial traceable record cannot be created. This situation leaves the financial controlling of the sales that has been carried out virtually up to the arbitrary decision of the e-commerce web site where said sales has been carried out. This in turn prevents the related regulatory institutions to perform healthy auditing in terms of comparing and matching the financial data.

In the known systems sales and payments are performed as two different procedures that are independent from each other. Such that, the payment can be performed right after the product or sales have been purchased, however the financial record (receipt, invoice, e-invoice, e-archiving etc) cannot be given to the person or the organization at the same time that has performed the purchasing process.

There are some improvements in the art, regarding the problems that have been mentioned below.

In the WO2008045007A2 numbered International patent document which belongs to the known state of the art an electronic receipt system for stores is described. The method subject to the invention comprises steps such as determining the total amount of payment at the sales point, and carrying out POS and ATM banking procedures via a mobile device. The payment is carried out by means of the POS device via the preferably wireless network after an approval has been received from the bank. An electronic receipt and payment details are sent to the user. In in this method however financial records are not mentioned.

In the WO2012012445A2 numbered International patent document which belongs to the known state of the art a mobile system and financial procedures are mentioned. Nowadays, POS, mobile trade, communication other systems similar to these are being improved and developed. Such mobile system comprises methods, system, web, e-commerce, virtual terminal, mobile personal digital assistant, mobile phones, and computer based procedures such as mobile devices and security bases procedures for mobile payment systems. The user can easily carry out payment by means of mobile devices such as mobile phones.

The aim of the invention is to provide a virtual sales, payment and reporting method which enable the recording of the sales transactions carried out via an e-commerce web site, and submitting said records of transaction to the related organizations, and an e-cash register POS system which operates in compliance with said method.

Another aim of the invention is to provide a virtual sales, payment and reporting method where the e-commerce sites are enabled to be integrated to both a virtual cash register and virtual pos medium from a single point and to provide an e-cash register pos system which operates in compliance with said method.

### BRIEF DESCRIPTION OF DRAWINGS

The virtual sales, payment and reporting method and an e-cash register pos system operating in compliance with said method that has been developed in order to reach the aims of the present invention has been shown in the attached drawings.

According to the figures;

FIG.-1 is the schematic view of an embodiment of the e-cash register pos system which operates in compliance with the method subject to the invention.

FIG.-2 is the flow diagram of an embodiment of the virtual payment and reporting method subject to the invention.

FIG.-3 is the schematic view of another embodiment of the e-cash register pos system which operates in compliance with the method subject to the invention

FIG.-4 is the flow diagram of another embodiment of the virtual payment and reporting method subject to the invention.

The parts in the figures have each been numbered as below:

1. Method

2. E-commerce site

3. Management centre

4. Virtual pos module

5. Bank

6. Regulatory institutions

7. Safety module

8. Virtual cash register pos

### DETAILED DESCRIPTION OF INVENTION

The virtual sales, payment and reporting method (1) subject to the invention comprises the following steps;
Starting the purchasing process from the e-commerce site (2) for the products that the user wants to purchase (100),
Requesting the information relating to the purchasing and payment procedure (110),

Submitting the information such as product, VAT, Trade registration number, total amount, payment type (Credit card, payment at the door, money order etc) via the safety module (7) to the management centre (3) and the virtual cash register pos (8) (120),
Submitting the payment transaction to the virtual pos module (4) from the management centre (3) and virtual cash register pos (8), (130),
Directing the payment transaction that has been carried out by the card, via the virtual pos module (4) to the bank (5) from which the card has been obtained, and receiving a provision from the related bank (5), (140),
Sending the information to the virtual pos module (4) first of all, after the provision has been received (150),
Creating financial records, by obtaining the payment information of the management centre (3) and virtual cash register pos (8), from the virtual pos module (4) (160),
Storing the sales and payment transactions that have been carried out within the management centre (3) and the virtual cash register pos (8) system for a long duration (170),
Transferring the information that has been reported which belongs to the sales and payment transactions from the management centre (3) and the virtual cash register pos (8) to the system of the regulatory institutions when such information is requested (180),
Submitting the information which belongs to the sales and payment transaction from the management centre (3) and the virtual cash register pos (8) to the safety module (7), (190), and
Re-sending the information via the safety module (7) to the e-commerce site (2), (200).

An e-cash register pos system operating in compliance with the virtual sales, payment and reporting method (1) subject to the invention comprises;
Any kind of electronic platform where goods and services can be purchased such as an E-commerce site (2) belonging to the tax payer,
Management centre (3) and virtual cash register pos (8) which receives the sales transactions that have been performed at an e-commerce site (2), via the safety module (7) and transfers it to a virtual pos (4), and which can report said transaction information to the regulatory institutions (6) when desired after a provision has been obtained from the bank from which the transaction has been carried out,
A virtual pos (4) which receives information of sales and payment procedures from the management centre (3) and the virtual cash register pos (8) and submits said information to the bank (5) and re-sends the information received from the related bank (5) back to the management centre (3) and the virtual cash register pos (8), and
A safety module (7) which enables secure data transaction between the e-commerce site (2) and the management centre (3) and virtual cash register-pos (8),

According to the virtual sales, payment and reporting method (1) and the e-cash register pos system operating in compliance with said method subject to the invention, the management centre (3) and the virtual cash register-pos (8) can be directly integrated to e-commerce sites (2) or can also be located in a separate virtual medium. In this case the medium where the management centre (3) and virtual cash register pos (8) and the e-commerce site (2) where all kinds of electronic sales procedures are carried out, can be connected to via the safety module (7) and the related sales transaction can be financially recorded and the data can be transferred to the related institutions.

The virtual sales, payment and reporting method and the virtual pos module (4) within the e-cash register pos system operating in compliance with said method, subject to the invention shall carry out the payment collections of payments that have been created by the management centre (3) and the virtual cash register pos (8) and shall receive the provision from the related banks (5) by connecting with the virtual payment modules of said banks. The results of said transactions can be transferred to the regulatory institutions according to the requests of said related regulatory institutions (6).

The e-commerce sites (2) do not need to perform virtual pos integration separately for each financial institution. When the management centre (3) and the virtual cash register pos (8) and the virtual pos module (4) are integrated to operate together according to the method (1) subject to the invention it shall be sufficient for the e-commerce site (2) to connect to only the management centre (3) and the virtual cash register pos module (8). By this means, it is enabled for the e-commerce sites (2) to be able to be integrated easily to both the virtual cash register (8) and the virtual pos from a single point.

In the virtual sales, payment and reporting method (1) and the virtual pos module (4) within the e-cash register pos system operating in compliance with said method, a traceable record can be established by means of the management centre (3) and the virtual cash register pos (8) at the same time of the sales transaction carried out from the e-commerce site. These records can be created in the management centre (3) and the virtual cash register pos (8) and then can be submitted to the regulatory institutions (6) via the management centre (3) and the virtual cash register-pos (8).

As the converting a sales procedure into a financial report and performing the payment can be carried out within the same integrated structure in the virtual sales, payment and reporting method and the virtual pos module (4) within the e-cash register pos system operating in compliance with said method, subject to the invention the sales and payment processes can be controlled on a single structure. Thereby it is possible to submit both the information regarding sales and payment and the reports consistently to the regulatory institutions (6).

By this means, unrecorded economy can be prevented, and it has been enabled for the transactions to be notified automatically by the system without the necessity for a person to check said transactions.

The virtual sales, payment and reporting method (1) subject to the invention comprises the below mentioned steps in another embodiment;
Starting the purchasing process from the e-commerce site (2) for the products that the user wants to purchase (300),
Requesting the information relating to the purchasing and payment procedure (310),
Submitting the information such as product, VAT, Trade registration number, total amount payment type (Credit card, payment at the door, money order, electronic funds transfer, transfer, electronic check, mobile etc) via the safety module (7) and the virtual cash register-pos (8) (320),
Submitting the payment transaction paid from the virtual cash register pos (8) to the management centre (3) (330),
Directing the payment transaction that has been carried out by the card, via the management centre (3) to the bank (5) from which the card has been obtained, and receiving a provision from the related bank (5), (340),
Sending the information to the virtual cash pos (8), after the provision has been received (350),
Creating financial records which cannot be changed or interfered with by obtaining the payment information of the virtual cash register pos (8) from the management centre (3) (360),
Storing the sales and payment transactions that have been carried out within the virtual cash register pos (8) system for a long duration of time (370),
Transferring the information that has been reported which belongs to the sales and payment transactions from the virtual cash register pos (8) by the management centre (3) to the system of the regulatory institutions when such information is requested (380),
Submitting the information which belongs to the sales and payment transaction carried out from the virtual cash register pos (8) to the safety module (7), (390), and
Re-sending the information via the safety module (7) to the e-commerce site (2), (400).

Another embodiment of the e-cash register pos system operating in compliance with the virtual sales, payment and reporting method (1) subject to the present invention comprises;
Any kind of electronic platform where goods and services can be purchased such as an E-commerce site (2) belonging to the tax payer,
A virtual cash register pos (8) which obtains the sales procedure details carried out via thee-commerce site (2) over the safety module (7) and submits it to the management centre (3) and then retrieves this information from the management centre (3) when a provision is obtained from the bank, carrying out the process and submits said information back to the safety module (7) and submits said information to the management centre (3) if required in order to be able to report to the regulatory institutions (6);
A management centre (3) to which the information for the sales and payment procedures carried out on a virtual cash register pos (8) is submitted to and which submits the received information to the related bank (5), and then re-submits the information received from the related bank (5) back to the virtual cash register pos (8), and obtains the information from the virtual cash register pos (8) if desired and reports said information to the regulatory institutions (6), and
a safety module (7) which enables reliable data transaction between the e-commerce site (2) and the virtual cash register pos (8).

According to this embodiment of the virtual sales, payment and reporting method (1) and the e-cash register pos system operating, in compliance with said method subject to the invention, the virtual cash register pos (8) can, not only be directly integrated with e-commerce sites (2) but can also be found in a different virtual medium. In such a case, the e-commerce site (2) through which all kinds of electronic sales procedures are carried out, connects via the safety module (7) to the medium where the virtual cash register pos (8) is located and financially records the related sales procedure and can transfer the data to the related places.

In an embodiment of the invention the virtual cash register pos (8) comprises a

special virtual cash register module that belongs to each e-commerce site (2) and one or more virtual pos modules that enable safe communication with banks (7). The virtual cash register pos (8), operates and manages the cash register and pos modules according to national and international regulations by means of a main application manager. In the virtual cash register pos (8) system the procedures are started on a cash register module and said procedures also end on a cash register module. Virtual electronic recording unit and virtual financial memory units where the e-receipt information are registered in are provided in the virtual cash register pos (8). The information registered in said units, can be submitted via the management centre (3) to the regulatory institutions (6) instantly or periodically when necessary. The virtual cash register pos (8) comprises applications such as e-electronic recording unit, e-financial memory, e-banking applications, e-cash register application and VAT applications.

The sales, payment and reporting method (1) subject to the invention and the management centre (3) which operates in compliance with said method located in the e-cash register pos system, carries out all of the collection procedures from the payment amount created by the virtual cash register pos (8) and connects with the virtual payment methods of the related banks (5) to obtain a provision. The result of all of these procedures can be submitted to the regulatory institutions (6) if required.

E-commerce sites (2) need to carry out independent virtual pos integration for each financial institution. When the management centre (3) and the virtual cash register pos (8) operate, being integrated with each other according to the method (1) subject to the invention, it is sufficient for the e-commerce site (2) to connect to the virtual cash register pos module (8).

According to the virtual sales, payment and reporting method (1) and the e-cash register pos system operating in compliance with said method, a trace-record is established by means of the virtual cash register pos (8) during the sales procedure carried out over the e-commerce site (2). These records are created in the virtual cash register pos (8) and can be sent to the regulatory institutions (6) via the management centre (3).

According to the virtual sales, payment and reporting method (1) and the e-cash register pos system operating in compliance with said method, as the conversion of a sales procedure into a financial transaction, and the payment transaction are carried out in an integrated structure, the sales and payment processes can be controlled on a single structure. Thereby it shall be possible to submit the reports and information related to both the sales and payment processes, to the regulatory institutions (6) coherently. By this means unrecorded economy is also prevented and it has been enabled for the procedures to be automatically notified without leaving said procedures to the arbitrary control of a person.

1. A virtual sales, payment and reporting method, comprising following step:
starting a purchasing process from an e-commerce site for products that an user wants to purchase,
requesting information relating to a purchasing and payment procedure,
submitting information including product, VAT, trade registration number, total amount, and payment type via a safety module to a management centre and a virtual cash register POS,
submitting a payment transaction to a virtual POS module from the management centre and the virtual cash register POS,
directing the payment transaction that has been carried out by a card, via the virtual POS module to a bank from which the card has been obtained, and receiving a provision from the bank,
sending the information to the virtual POS module first, after the provision has been received,
creating financial records, by obtaining payment information of the management centre and the virtual cash register POS, from the virtual POS module,
storing sales and payment transactions that have been carried out within the management centre and the virtual cash register POS system for a long duration,
transferring information that has been reported and belongs to the sales and payment transactions from the management centre and the virtual cash register POS to a system of regulatory institutions when such information is requested,
submitting the information which belongs to the sales and payment transactions from the management centre and the virtual cash register POS to the safety module, and
re-sending the information which belongs to the sales and payment transactions from the management centre via the safety module to the e-commerce site.

2. An e-cash register POS system operating in compliance with the virtual sales, payment and reporting method according to claim 1, comprising:
an electronic platform where goods and services can be purchased,
the virtual POS module which receives information of sales and payment procedures from the management centre and the virtual cash register POS and submits the information of sales and payment procedures from the management centre and the virtual cash register POS to the bank and re-sends information received from the bank back to the management centre and the virtual cash register POS, and
the safety module which enables secure data transaction between the e-commerce site and the management centre and the virtual cash register POS;
wherein
the management centre and the virtual cash register POS receives sales transactions that have been performed at an e-commerce site via the safety module, transfers the sales transactions to the virtual POS module, and reports transaction information to the regulatory institutions after a provision has been obtained from the bank where a transaction has been carried out.

3. A virtual sales, payment and reporting method, comprising following steps:
starting a purchasing process from an e-commerce site for products that an user wants to purchase,
requesting information relating to a purchasing and payment procedure,
submitting information including, product, VAT, trade registration number, total amount, and payment type via a safety module and a virtual cash register POS,
submitting a payment transaction paid from the virtual cash register POS to a management centre,
directing a payment transaction that has been carried out by a card, is the management centre to a bank from which the card has been obtained, and receiving a provision from the bank,
sending information to the virtual cash POS, after the provision has been received,
creating financial records which cannot be changed or interfered with by obtaining payment information of the virtual cash register POS from the management centre,
storing sales and payment transactions that have been carried out within the virtual cash register POS system for a long duration of time,
transferring information that has been reported and belongs to the sales and payment transactions from the virtual cash register POS by the management centre to a system of regulatory it when such information is requested,
submitting information which belongs to the sales and payment transactions carried out from the virtual cash register POS to the safety module, and
re-sending the information which belongs to the sales and payment transactions carried out from the virtual cash register POS via the safety module to the e-commerce site.

4. An e-cash register POS system, comprising:
an electronic platform where goods and services can be purchased,
A safety module which enables reliable data transaction between an e-commerce site and a virtual cash register POS,
wherein
the virtual cash register POS which obtains sales procedure details carried out via the e-commerce site over the safety module and submits it to a management centre and then retrieves information from the management centre when a provision is obtained from a bank, carrying out a process and submits information back to the safety module and submits the information to the management centre if required in order to be reported to regulatory institutions; and
the management centre to which information for sales and payment procedures carried out on the virtual cash register POS is submitted to and which submits received information to the bank, and then re-submits information received from the bank back to the virtual cash register POS, and obtains information from the virtual cash register POS and reports information to the regulatory institutions.

5. The virtual sales, payment and reporting method of claim 1, wherein the payment type is selected from the group consisting of credit card, payment at the door, and money order.

6. The e-cash register POS system of claim 2, wherein the payment type is selected from the group consisting of credit card, payment at the door, and money order.

7. The virtual sales, payment and reporting method of claim 3, wherein the payment type is selected from the group consisting of credit card, payment at the door, and money order.
